(19) United States
(12) Patent Application Publication
(10) Pub. No.: US 2023/0192061 A1
(43) Pub. Date: Jun. 22, 2023

(54) TEMPERATURE ESTIMATION METHOD, TEMPERATURE ESTIMATION DEVICE, AND NON-TRANSITORY COMPUTER-READABLE RECORDING MEDIUM

(71) Applicant: TOYOTA JIDOSHA KABUSHIKI KAISHA, Toyota-shi (JP)

(72) Inventors: Yoshiyuki FURUTA, Sunto-gun (JP); Toru MATSUSHIMA, Machida-shi (JP); Yoshihiro OSAWA, Numazu-shi (JP)

(73) Assignee: TOYOTA JIDOSHA KABUSHIKI KAISHA, Toyota-shi (JP)

(21) Appl. No.: 18/047,016

(22) Filed: Oct. 17, 2022

(30) Foreign Application Priority Data
Dec. 16, 2021 (JP) 2021-204564

(51) Int. Cl. B60T 17/22; G01K 11/00; F16D 66/00

(52) U.S. Cl. CPC B60T 17/22; G01K 11/00; F16D 66/00; F16D 2066/001; F16D 2066/006; B60T 2210/20; B60T 2250/04; B60T 2270/60

(57) ABSTRACT

A brake device applies a braking force to a vehicle by pressing a friction material against a rotor rotating integrally with a wheel. A temperature estimation method applied to the brake device includes: calculating an amount of absorbed energy absorbed by the rotor based on an amount of kinetic energy that the vehicle loses and an amount of potential energy that the vehicle loses during braking of the vehicle; and estimating a temperature of the rotor based on the amount of absorbed energy.

### CROSS-REFERENCE TO RELATED APPLICATION

This application claims priority to Japanese Patent Application No. 2021-204564 filed on Dec. 16, 2021, the entire contents of which are incorporated by reference herein.

### BACKGROUND

### Technical Field

The present disclosure relates to a technique for estimating a brake temperature of a vehicle.

### Background Art

Patent Document 1 discloses a control device for detecting progress of wear of a braking mechanism of a vehicle. The control device comprises a temperature calculation unit for calculating a temperature of a brake disc. The temperature calculation unit calculates an increased temperature amount based on a fact that a kinetic energy of the vehicle is converted into a thermal energy due to friction between the brake disc and a brake pad during braking of the vehicle. Further, the temperature calculation unit calculates a cooled temperature amount based on a fact that the brake disc is cooled by outside air. The temperature calculation unit calculates the temperature of the brake disc based on the increased temperature amount and the cooled temperature amount.

### LIST OF RELATED ART

Patent Document 1: Japanese Laid-Open Patent Application Publication No.

### SUMMARY

In the technique described in Patent Document 1, the temperature calculation unit estimates the brake temperature by regarding an amount of change in kinetic energy of the vehicle as a frictional energy generated by the braking. However, when the braking is performed while the vehicle is traveling on a slope, the kinetic energy increases or decreases by an amount of change in potential energy of the vehicle regardless of the braking. Therefore, if the brake temperature is estimated by simply regarding the amount of change in kinetic energy as the frictional energy, the temperature estimation accuracy is deteriorated.

An object of the present disclosure is to provide a technique capable of estimating a brake temperature of a vehicle with higher accuracy.

A first aspect is directed to a temperature estimation method applied to a brake device that applies a braking force to a vehicle by pressing a friction material against a rotor rotating integrally with a wheel.

The temperature estimation method includes:

calculating an amount of absorbed energy absorbed by the rotor based on an amount of kinetic energy that the vehicle loses and an amount of potential energy that the vehicle loses during braking of the vehicle; and

estimating a temperature of the rotor based on the amount of absorbed energy.

A second aspect further has the following feature in addition to the first aspect.

the amount of absorbed energy includes a sum of an amount of first absorbed energy based on the amount of kinetic energy that the vehicle loses and an amount of second absorbed energy based on the amount of potential energy that the vehicle loses.

A third aspect further has the following feature in addition to the first or second aspect.

The temperature estimation method further includes calculating the amount of potential energy based on a slope angle of a road surface on which the vehicle travels and a vehicle speed of the vehicle.

A fourth aspect further has the following feature in addition to any one of the first to third aspects.

The temperature estimation method further includes calculating the amount of potential energy based on altitude information of a travel position of the vehicle obtained from three dimensional map information.

A fifth aspect further has the following feature in addition to any one of the first to fourth aspects.

An amount of regenerative energy is an energy amount of a regenerative braking force applied to the vehicle by a regenerative braking device mounted on the vehicle.

Calculating the amount of absorbed energy includes calculating the amount of absorbed energy based on the amount of kinetic energy that the vehicle loses, the amount of potential energy that the vehicle loses, and the amount of regenerative energy.

A sixth aspect further has the following feature in addition to any one of the first to fifth aspects.

The amount of absorbed energy includes a sum of an amount of first absorbed energy based on the amount of kinetic energy that the vehicle loses, an amount of second absorbed energy based on the amount of potential energy that the vehicle loses, and an amount of third absorbed energy based on the amount of regenerative energy.

A seventh aspect further has the following feature in addition to the fifth or sixth aspect.

The temperature estimation method includes calculating the amount of regenerative energy based on a regenerative torque applied to the regenerative braking device.

An eighth aspect is directed to a temperature estimation device applied to a brake device that applies a braking force to a vehicle by pressing a friction material against a rotor rotating integrally with a wheel.

The temperature estimation device includes one or more processors.

The one or more processors are configured to:

calculate an amount of absorbed energy absorbed by the rotor based on an amount of kinetic energy that the vehicle loses and an amount of potential energy that the vehicle loses during braking of the vehicle; and

estimate a temperature of the rotor based on the amount of absorbed energy.

A ninth aspect is directed to a temperature estimation program applied to a brake device that applies a braking force to a vehicle by pressing a friction material against a rotor rotating integrally with a wheel.

The temperature estimation program causes a computer to execute:

calculating an amount of absorbed energy absorbed by the rotor based on an amount of kinetic energy that the vehicle loses and an amount of potential energy that the vehicle loses during braking of the vehicle; and

estimating a temperature of the rotor based on the amount of absorbed energy.

According to the present disclosure, the rotor temperature (brake temperature) is estimated in consideration of the amount of kinetic energy and the amount of potential energy that the vehicle loses during braking. Therefore, the estimation accuracy of the brake temperature is improved as compared with a case where the amount of change in potential energy is not taken into consideration.

### BRIEF DESCRIPTION OF DRAWINGS

FIG. 1 is a schematic diagram showing a configuration of a vehicle according to an embodiment of the present disclosure;

FIG. 2 is a block diagram schematically showing a configuration of a brake device according to an embodiment of the present disclosure;

FIG. 3 is a conceptual diagram for explaining a change in potential energy of the vehicle according to an embodiment of the present disclosure;

FIG. 4 is a block diagram showing a configuration example of the vehicle according to an embodiment of the present disclosure;

FIG. 5 is a block diagram showing a functional configuration example of a temperature estimation device according to an embodiment of the present disclosure;

FIG. 6 is a flowchart showing an initial temperature calculation process performed by the temperature estimation device according to an embodiment of the present disclosure;

FIG. 7 is a flowchart showing a brake temperature calculation process performed by the temperature estimation device according to an embodiment of the present disclosure;

FIG. 8 is a block diagram showing a configuration example of the vehicle according to a first modification example of the embodiment of the present disclosure;

FIG. 9 is a block diagram showing a configuration example of the vehicle according to a second modification example of the embodiment of the present disclosure;

FIG. 10 is a block diagram showing a functional configuration example of the temperature estimation device according to the second modification example of the embodiment of the present disclosure; and

FIG. 11 is a flowchart showing a brake temperature calculation process performed by the temperature estimation device according to the second modification example of the embodiment of the present disclosure.

### EMBODIMENTS

Embodiments of the present disclosure will be described with reference to the accompanying drawings.

### 1. Overview

### 1-1. Vehicle and Brake Device

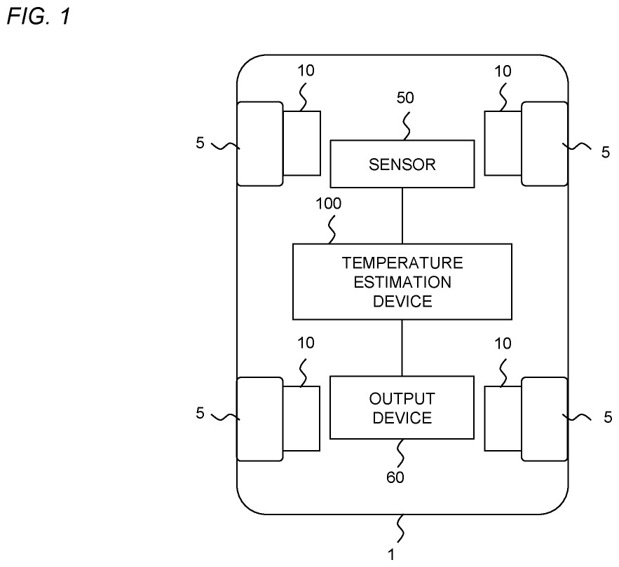

FIG. 1 is a schematic diagram showing a configuration of a vehicle 1 according to the present embodiment. The vehicle 1 may be an autonomous driving vehicle controlled by an autonomous driving system. The vehicle 1 is equipped with wheels (tires) 5 and a brake device 10. The brake device 10 generates a braking force in response to a brake operation by a driver or the autonomous driving system.

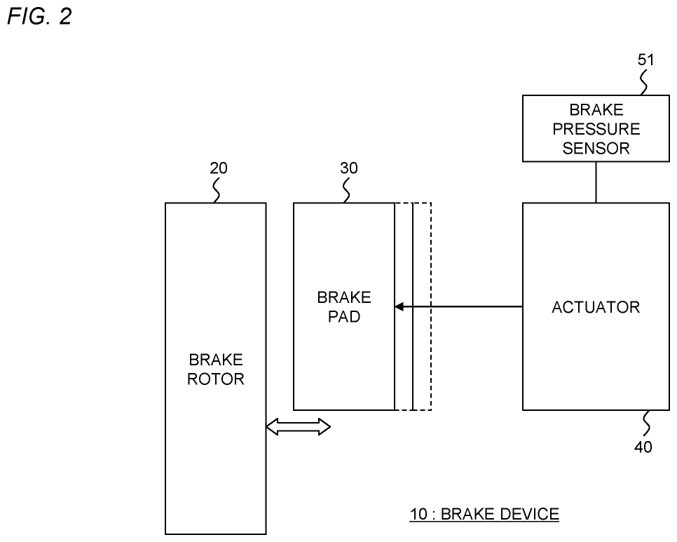

FIG. 2 is a block diagram schematically showing a configuration of the brake device 10 according to the present embodiment. The brake device 10 includes a brake rotor 20, a brake pad 30, and an actuator 40.

The brake rotor 20 is a rotating member that rotates together with the wheel 5. For example, a material of the brake rotor 20 is cast iron. The brake pad 30 is a friction material that comes into contact with the brake rotor 20. For example, the brake pad 30 is formed by baking a composite material including a variety of organic fibers and inorganic fibers with a resin.

The actuator 40 moves the brake pad 30 and presses it against the brake rotor 20 in response to the brake operation by the driver or the autonomous driving system. More specifically, the actuator 40 generates a brake pressure Pb in response to the brake operation, and presses the brake pad 30 against the brake rotor 20 by the brake pressure Pb. For example, the actuator 40 includes a master cylinder and a caliper. In response to the brake operation, the master cylinder pushes out a brake fluid to the caliper to generate the brake pressure (brake fluid pressure) Pb. Due to the brake pressure Pb, a piston in the caliper pushes out the brake pad 30 and presses it against the brake rotor 20. Thus, a braking force is generated.

During the braking of the vehicle 1, the brake pad 30 is pressed against the brake rotor 20 rotating together with the wheel 5 and thus the braking force is generated. At this time, frictional heat is generated due to the contact between a surface of the brake rotor 20 and a surface of the brake pad 30, and thus a temperature of the brake rotor 20 increases. When the temperature of the brake rotor 20 becomes higher than a certain threshold value, a fading phenomenon or the like may be caused. Therefore, it is necessary to notify the driver or the autonomous driving system to take measures such as a safe stop of the vehicle. For this purpose, it is necessary to estimate the temperature of the brake rotor 20. Hereinafter, a method of estimating the temperature will be described. In the following description, the terms “temperature of the brake rotor 20” and “brake temperature” have the same meaning.

### 1-2. Temperature Estimation Process

A temperature estimation device 100 is applied to the brake device 10 described above, and performs a temperature estimation process for estimating the temperature of the brake rotor 20. As shown in FIG. 1, the temperature estimation device 100 is typically mounted on the vehicle 1. However, the temperature estimation device 100 may be included in an external device (e.g.: a management server) outside the vehicle 1.

During the braking of the vehicle 1, the frictional heat is generated due to the contact between the surface of the brake rotor 20 and the surface of the brake pad 30, and thus the temperature of the brake rotor 20 increases. As a method for estimating the temperature of the brake rotor 20, it may be conceivable to calculate an amount of frictional energy of the frictional heat and convert the amount of frictional energy into an amount of temperature variation of the brake rotor 20. However, it is difficult to directly calculate the amount of frictional energy.

Therefore, as a method for performing the temperature estimation, it is conceivable to obtain a change in kinetic energy caused by the friction, instead of calculating the amount of frictional energy. An amount of the change in kinetic energy corresponds to the amount of frictional energy.

When it is assumed that a vehicle speed of the vehicle 1 changes from V_{before} to V during a time Δt, an amount of kinetic energy ΔK that the vehicle 1 loses is expressed by the following Equation (1).

### [Equation 1]

$$Δ K = \frac{1}{2} M ( {V}_{before}^{2} - {V}^{2} ) \qquad ( 1 )$$

Here, M is a mass of the vehicle 1. The amount of kinetic energy ΔK has a positive value when the kinetic energy of the vehicle 1 decreases, and has a negative value when the kinetic energy of the vehicle 1 increases. The amount of kinetic energy ΔK that the vehicle 1 loses is the amount of decrease in the kinetic energy of the vehicle 1.

The values of the vehicle speeds V and V_{before} in Equation (1) can be acquired by an existing wheel speed sensor. Further, the mass M is a known value. Therefore, the amount of kinetic energy ΔK can be easily calculated.

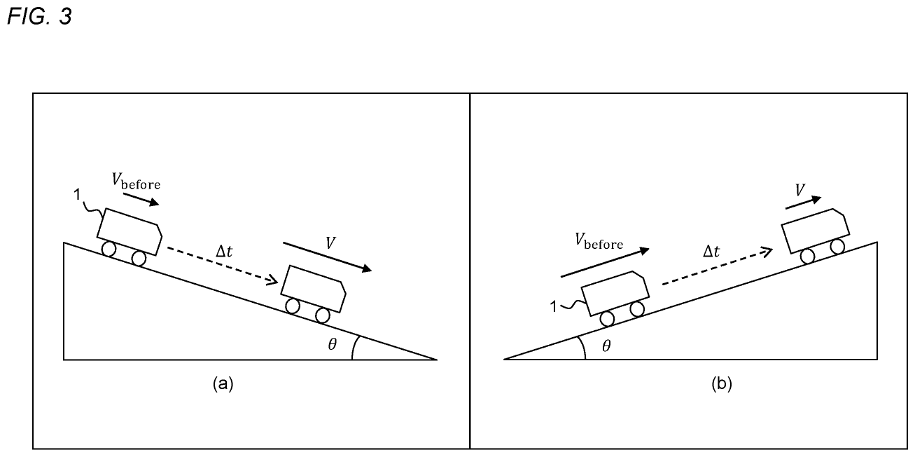

However, the change in vehicle speed is not necessarily caused only by the braking. The change in vehicle speed is also caused by gradient of a road on which the vehicle 1 travels. The change in vehicle speed caused by the gradient of the road will be described with reference to FIG. 3. A part (a) in FIG. 3 illustrates a case in which the vehicle 1 is running downhill. The vehicle speed increases from V_{before} to V due to a road surface direction component of a force of gravity applied to the vehicle 1. A part (b) in FIG. 3 illustrates a case in which the vehicle 1 is running uphill. The vehicle speed decreases from V_{before} to V due to a road surface direction component of the force of gravity applied to the vehicle 1. Such the increase or decrease in the vehicle speed is caused by a change in potential energy of the vehicle 1 based on the gradient of the road. That is, when the potential energy of the vehicle 1 changes, the vehicle speed also changes accordingly.

Therefore, the term (V²_{before}−V²) representing the change in vehicle speed in Equation (1) is not necessarily entirely caused by the friction, but is partially caused by the change in potential energy. Therefore, if the amount of frictional energy is calculated by using the Equation (1) as it is to estimate the temperature of the brake rotor 20, the accuracy of the temperature estimation may be deteriorated.

In view of the above, according to the present embodiment, the temperature of the brake rotor 20 is estimated in consideration of not only the amount of change in kinetic energy of the vehicle 1 but also the amount of change in potential energy of the vehicle 1.

The temperature estimation process is performed based on an amount of absorbed energy Qᵢₙ absorbed by the brake rotor 20. The amount of absorbed energy Qᵢₙ includes a sum of an amount of first absorbed energy Qᵢₙ₁ based on the amount of kinetic energy that the vehicle 1 loses during the braking and an amount of second absorbed energy Qᵢₙ₂ based on the amount of potential energy that the vehicle 1 loses during the braking. That is, the amount of absorbed energy Qᵢₙ is expressed by the following Equation (2).

[Equation 2]

Qᵢₙ=Qᵢₙ₁+Qᵢₙ₂ (2)

It should be noted that the amount of absorbed energy Qᵢₙ may further include a term based on an amount of another energy. For example, when the vehicle 1 is an electric vehicle provided with a regenerative braking device, the amount of absorbed energy Qᵢₙ may further include an amount of third absorbed energy Qᵢₙ₃ based on an amount of regenerative energy.

The amount of first absorbed energy Qᵢₙ₁ absorbed by the brake rotor 20 of one of four wheels 5 is expressed by the following Equation (3).

$$[ Equation 3 ]$$

$${Q}_{in 1} = {Δ K αC}_{1} {C}_{2} * \frac{1}{2} = \frac{1}{2} M ( {V}_{before}^{2} - {V}^{2} ) {α C}_{1} {C}_{2} * \frac{1}{2} \qquad ( 3 )$$

Here, α is a front-rear braking force distribution. C₁ is a running resistance loss coefficient that is a coefficient representing an energy loss caused by air resistance that the vehicle 1 faces, resistance due to friction between the wheel 5 and a road surface, and the like. C₂ is a thermal loss coefficient based on thermal loss at portions other than a sliding portion between the brake rotor 20 and the brake pad 30. The last coefficient ½ represents that the thermal energy is distributed to the brakes of two wheels 5 on the left and right.

A method of calculating the amount of second absorbed energy Qᵢₙ₂ will be described. When it is assumed that the vehicle 1 travels on a slope having a slope angle θ at a vehicle speed V during a time Δt, the amount of potential energy ΔU that the vehicle 1 loses is represented by the following Equation (4).

[Equation 4]

ΔU=MgVΔt sin θ (4)

Here, g is the acceleration of gravity. The amount of potential energy ΔU that the vehicle 1 loses is positive when the potential energy of the vehicle 1 decreases, and negative when the potential energy of the vehicle 1 increases. Therefore, the slope angle θ is defined to be positive in the case of downhill (i.e., in the case of (a) in FIG. 3) and negative in the case of uphill (i.e., in the case of (b) in FIG. 3). The amount of potential energy ΔU that the vehicle 1 loses is the amount of decrease in the potential energy of the vehicle 1.

Based on the amount of potential energy ΔU, the amount of second absorbed energy Qᵢₙ₂ absorbed by the brake rotor 20 of one of the four wheels 5 is expressed by the following Equation (5).

$$[ Equation 5 ]$$

$${Q}_{in 2} = {Δ U αC}_{1} {C}_{2} * \frac{1}{2} = \frac{1}{2} {MgV Δ t sinθα C}_{1} {C}_{2} * \frac{1}{2} \qquad ( 5 )$$

The last coefficient ½ represents that the thermal energy is distributed to the brakes of two wheels 5 on the left and right.

As described above, the temperature estimation device 100 calculates the amount of absorbed energy Qᵢₙ absorbed by the brake rotor 20 by using the amount of first absorbed energy Qᵢₙ₁ represented by Equation (3) and the amount of second absorbed energy Qᵢₙ₂ represented by Equation (5).

Next, an amount of energy that the brake rotor 20 loses during the time Δt will be described. During the time Δt, the brake rotor 20 is cooled by atmosphere, and thus an amount of released energy Qₒᵤₜ is released into the atmosphere. The amount of released energy Qₒᵤₜ is expressed by the following Equation (6).

[Equation 6]

Qₒᵤₜ=h*A*(T_{before}−Tₐₜₘ)*Δt (6)

Here, h is a thermal conductivity when the brake rotor 20 releases heat to the outside, A is an area of the sliding portion between the brake rotor 20 and the brake pad 30, and Tₐₜₘ is an outside air temperature. T_{before} is a temperature of the brake rotor 20 before the time Δt. The thermal conductivity h is a value that varies depending on the vehicle speed V, and is expressed as a function f of the vehicle speed V (h=f(V)). The function f may be a mathematical expression or a map.

Based on the amount of absorbed energy Qᵢₙ and the amount of released energy Qₒᵤₜ thus calculated, an amount of temperature change ΔT of the brake rotor 20 during the time Δt is expressed by the following Equation (7).

$$[ Equation 7 ]$$

$$Δ T = \frac{{Q}_{in} - {Q}_{out}}{{w}_{b} C} \qquad ( 7 )$$

Here, w_{b} is a mass of the brake rotor 20, and C is a specific heat of the brake rotor 20. The temperature estimation device 100 updates the temperature of the brake rotor 20 by using a temperature at the time of the previous temperature estimation and the amount of temperature change ΔT. In this manner, the temperature estimation process is realized.

According to the temperature estimation device 100 described above, the temperature of the brake rotor 20 can be estimated in consideration of the amount of kinetic energy ΔK and the amount of potential energy ΔU that the vehicle 1 loses during the braking. It is therefore possible to estimate the temperature of the brake rotor 20 with higher accuracy as compared with a case of the related art where the amount of change in potential energy is not taken into consideration. Moreover, since there is no need to provide a temperature sensor for directly measuring the temperature of the brake rotor 20, the number of components can be reduced.

Hereinafter, the present embodiment will be described in more detail.

### 2. Configuration Example

### 2-1. Vehicle

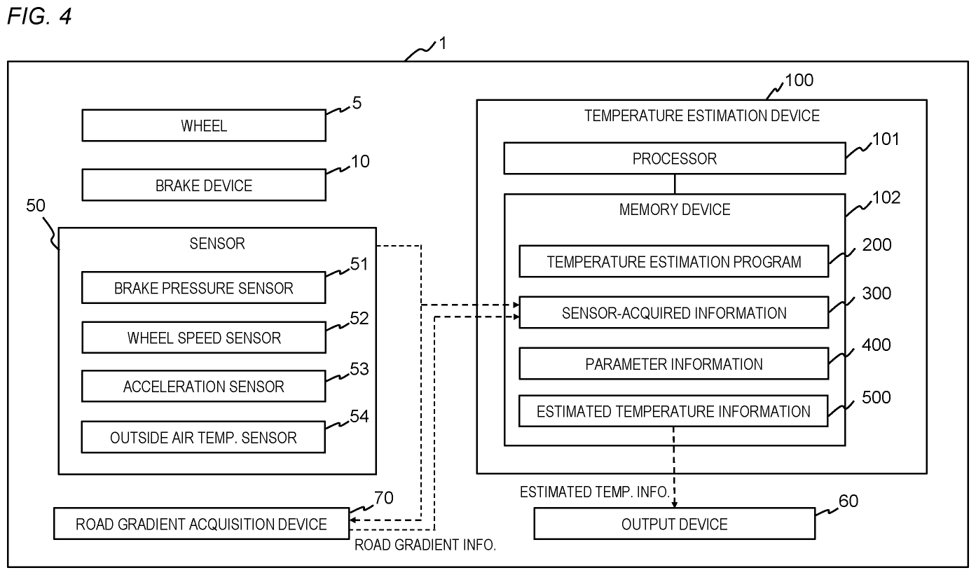

FIG. 4 is a block diagram showing a configuration example of the vehicle 1 according to the present embodiment. The vehicle 1 includes the wheels 5, the brake device 10, sensors 50, an output device 60, a road gradient acquisition device 70, and the temperature estimation device 100.

The functions and configurations of the wheel 5 and the brake device 10 are as described above.

The sensors 50 include a brake pressure sensor 51, a wheel speed sensor 52, an acceleration sensor 53, and an outside air temperature sensor 54. Each sensor transmits an acquired value to the road gradient acquisition device 70 and a memory device 102 through a wired network or a wireless network.

The brake pressure sensor 51 acquires the brake pressure Pb. The acquired brake pressure Pb is used for determining whether or not the vehicle 1 is braking.

The wheel speed sensor 52 acquires a wheel speed of each wheel 5. The vehicle speed V of the vehicle 1 can be calculated from the acquired wheel speed.

The acceleration sensor 53 acquires a longitudinal acceleration “a” of the vehicle 1.

The outside air temperature sensor 54 acquires the outside air temperature Tₐₜₘ.

The road gradient obtaining device 70 calculates the slope angle θ (i.e., an angle θ between a horizontal plane and a road surface on which the vehicle 1 travels) of the road on which the vehicle 1 travels, by using the longitudinal acceleration a of the vehicle acquired by the acceleration sensor 53. The longitudinal acceleration a of the vehicle acquired by the acceleration sensor 53 include an acceleration a₁ based on a change in vehicle speed and an acceleration a₂ based on a travel direction component of the acceleration of gravity. That is, the longitudinal acceleration a is expressed by the following Equation (8).

[Equation 8]

a=a₁+a₂ (8)

Here, a₁ can be calculated based on an amount of change in the vehicle speed V acquired by the wheel speed sensor 52. Therefore, the acceleration a₂ based on the travel direction component of the acceleration of gravity is expressed by the following Equation (9).

[Equation 9]

a₂=a−a₁ (9)

Since the acceleration a₂ is the travel direction component of the acceleration of gravity g, the acceleration a₂ can also be expressed by the following Equation (10).

[Equation 10]

a₂=g sin θ (10)

The slope angle θ of the road on which the vehicle 1 travels is calculated by using the relationships represented by Equations (9) and (10) described above.

It should be noted that the road gradient acquisition device 70 may be included in the temperature estimation device 100.

The output device 60 gives notification to a driver of the vehicle according to a result of the temperature estimation by the temperature estimation device 100. For example, information indicating that the temperature of the brake rotor 20 has become higher than a predetermined threshold value is notified. As another example, information indicating that measures such as a safe stop of the vehicle should be taken is notified, based on the fact that the temperature has become higher than the predetermined threshold value. The output device 60 may be configured by a speaker and may give audio notification to the driver. As another example, the output device 60 may be configured by a display and may give notification to the driver through visual representation. The display in this case may be the same as a display of a car navigation device provided in the vehicle 1 or a display of an instrument panel.

### 2-2. Temperature Estimation Device

The temperature estimation device 100 is a computer that executes a variety of information processing. The temperature estimation device 100 includes one or more processors 101 and one or more memory devices 102. The processor 101 executes a variety of information processing. For example, the processor 101 includes a central processing unit (CPU). The memory device 102 stores a variety of information necessary for the processing by the processor 101. The memory device 102 includes a volatile memory and a non-volatile memory. A part of the memory device 102 may be included in an external server or a mobile terminal. A temperature estimation program 200, sensor-acquired information 300, parameter information 400, and estimated temperature information 500 are stored in the memory device 102.

### 2-3. Temperature Estimation Program

The temperature estimation program 200 is a computer program executed by the computer. The functions of the temperature estimation device 100 (the processor 101) are realized by the processor 101 executing the temperature estimation program 200. The temperature estimation program 200 is stored in the memory device 102. The temperature estimation program 200 may be recorded in a non-transitory computer-readable recording medium. The temperature estimation program 200 may be provided via a network.

### 2-4. Sensor-Acquired Information

The sensor-acquired information 300 is information acquired by the sensor 50 mounted on the vehicle 1, and includes the brake pressure Pb, the vehicle speed V, the longitudinal acceleration a, and the outside air temperature Tₐₜₘ. The sensor-acquired information 300 also includes the slope angle θ acquired by the road gradient acquisition device 70. The processor 101 acquires the sensor-acquired information 300 based on a result of detection by the sensor 50. The sensor-acquired information 300 is stored in the memory device 102.

### 2-5. Parameter Information

The parameter information 400 is information of a variety of parameters used in the temperature estimation process. The parameter information 400 includes the mass M of the vehicle 1, the front-rear braking force distribution a, the running resistance loss coefficient C₁, the thermal loss coefficient C₂, the acceleration of gravity g, the thermal conductivity h, the sliding portion surface A between the brake rotor 20 and the brake pads 30, the mass w_{b} of the brake rotor 20, and the specific heat C of the brake rotor 20. In addition, the parameter information 400 includes the function f (a mathematical expression or a map) indicating the relationship between the thermal conductivity h and the vehicle speed V. The front-rear braking force distribution a is a value determined according to a road surface state and a travel state of the vehicle 1 when the braking is performed, and is appropriately acquired from a brake ECU included in the vehicle 1. The parameter information 400 may further include other parameters, functions, and the like necessary for the temperature estimation process. The parameter information 400 is stored in the memory device 102.

### 2-6. Estimated Temperature Information

The estimated temperature information 500 indicates the amount of temperature change ΔT estimated (calculated) by the temperature estimation device 100 (processor 101), and the temperature T_{R} of the brake rotor 20 estimated based on the amount of temperature change ΔT. The estimated temperature information 500 is stored in the memory device 102. The estimated temperature information 500 is transmitted to the output device 60 or the autonomous driving system of the vehicle 1, and is used for determining whether or not it is necessary to take measures such as a safe stop of the vehicle.

### 3. Processing Example by Temperature Estimation Device

### 3-1. Functional Configuration

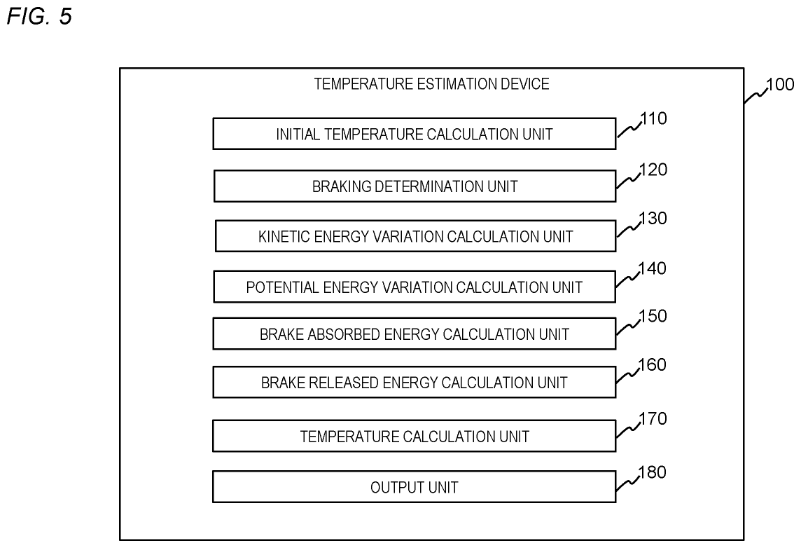

FIG. 5 is a block diagram showing a functional configuration of the temperature estimation device 100 according to the present embodiment. The temperature estimation device 100 includes, as its functional configuration, an initial temperature calculation unit 110, a braking determination unit 120, a kinetic energy variation calculation unit 130, a potential energy variation calculation unit 140, a brake absorbed energy calculation unit 150, a brake released energy calculation unit 160, a temperature calculation unit 170, and an output unit 180. These functional blocks are realized by the processor 101 executing the temperature estimation program 200.

### 3-2. Initial Temperature Calculation Process

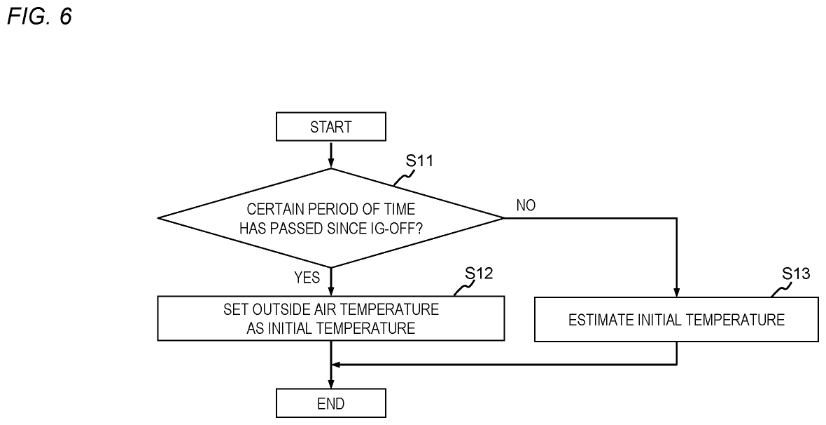

FIG. 6 is a flowchart showing an initial temperature calculation process for calculating an initial temperature T_{R0} of the brake rotor 20. The initial temperature calculation process is executed at a time of IG-ON of the vehicle 1.

In Step S11, the initial temperature calculation unit 110 determines whether or not a predetermined time or more has passed since the previous IG-OFF. The “predetermined time” is a period of time in which the brake rotor 20 is sufficiently cooled by the outside air, which is obtained in advance through experiment. When the predetermined time or more has passed (Step S11; Yes), the processing proceeds to Step S12. In Step S12, the initial temperature calculation unit 110 sets the outside air temperature Tₐₜₘ as an initial temperature T_{R0}.

On the other hand, when the predetermined time or more has not passed since the previous IG-OFF (Step S11; No), the processing proceeds to Step S13. In Step S13, the initial temperature calculation unit 110 calculates the initial temperature T_{R0} of the brake rotor 20 in consideration of cooling by the outside air. The initial temperature T_{R0} where cooling by outside air is taken into consideration is expressed by the following Equation (11).

$$[ Equation 11 ]$$

$${T}_{R 0} = ( {T}_{R , IGOFF} - {T}_{atm} ) exp ( - \frac{{h}_{stop} A}{{w}_{b} c} {t}_{IGOFF} ) + {T}_{atm} \qquad ( 11 )$$

Here, T_{R},I_{GOFF} is an estimated temperature of the brake rotor 20 at a time of the previous IG-OFF, hₛₜₒₚ is a thermal conductivity when the brake rotor 20 releases heat to the outside while the vehicle is stopped, and t_{IGOFF} is an elapsed time from the time of the previous IG-OFF.

In this manner, the initial temperature calculation unit 110 calculates the initial temperature T_{R0}.

### 3-3. Brake Temperature Calculation Process

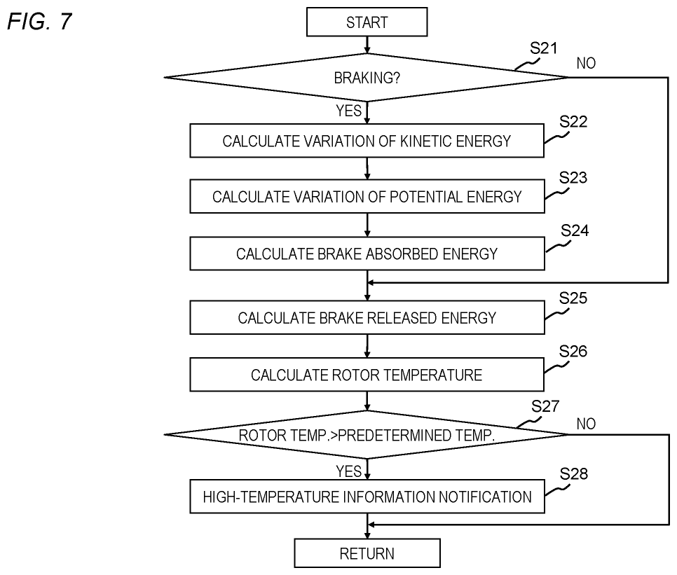

FIG. 7 is a flowchart showing a brake temperature calculation process. The brake temperature calculation process is performed at a predetermined time interval Δt while the vehicle 1 is in the IG-ON state.

In Step S21, the braking determination unit 120 determines whether or not the vehicle 1 is braking. The braking determination unit 120 determines that the vehicle 1 is braking when the brake pressure Pb is equal to or greater than a predetermined threshold value, and determines that the vehicle 1 is not braking when the brake pressure Pb is less than the predetermined threshold value. The braking determination process may be performed by other methods. For example, the braking determination unit 120 may acquire a detection value detected by a stroke sensor provided in a brake pedal of the vehicle 1 and determine whether or not the vehicle 1 is braking based on whether or not the detection value is equal to or greater than a predetermined threshold value.

When it is determined that the vehicle 1 is not braking (Step S21; No), the processing proceeds to Step S25. On the other hand, when it is determined that the vehicle 1 is braking (Step S21; Yes), the processing from Step S22 to Step S24 is performed. In Step S22, the kinetic energy variation calculation unit 130 calculates the amount of kinetic energy ΔK that the vehicle 1 loses during the time Δt. Equation (1) is used for calculating the amount of kinetic energy ΔK. In Step S23, the potential energy variation calculation unit 140 calculates the amount of potential energy ΔU that the vehicle 1 loses during the time Δt. Equation (4) is used for calculating the amount of potential energy ΔU. Next, in Step S24, the brake absorbed energy calculation unit 150 calculates the amount of absorbed energy Qᵢₙ absorbed by the brake rotor 20 during the time Δt by using Equations (1) to (5) on the basis of the amount of kinetic energy ΔK and the amount of potential energy ΔU. Thereafter, the processing proceeds to Step S25.

In Step S25, the brake released energy calculation unit 160 calculates the amount of released energy Qₒᵤₜ released by the brake rotor 20 during the time Δt. Equation (6) is used for calculating the amount of released energy Qₒᵤₜ. Next, in Step S26, the temperature calculation unit 170 calculates the temperature T_{R} of the brake rotor 20. First, the temperature calculation unit 170 calculates the amount of temperature change ΔT of the brake rotor 20 based on Equation (7) using the amount of absorbed energy Qᵢₙ absorbed by the brake rotor 20 and the amount of released energy Qₒᵤₜ released by the brake rotor 20. Thereafter, the temperature calculation unit 170 calculates the temperature T_{R} of the brake rotor 20 by adding the amount of temperature change ΔT to the temperature T_{before} at the time of previous estimation.

In Step S27, the output unit 180 determines whether or not the temperature T_{R} of the brake rotor 20 is equal to or higher than a predetermined temperature. When the temperature T_{R} of the brake rotor 20 is equal to or lower than the predetermined temperature (Step S27; No), the processing in the current cycle ends.

On the other hand, when the temperature T_{R} of the brake rotor 20 exceeds the predetermined temperature (Step S27; Yes), the processing proceeds to Step S28. In Step S28, the output unit 180 transmits the estimated temperature information 500 to the output device 60 or the autonomous driving system of the vehicle 1. The estimated temperature information 500 transmitted is used for determining whether it is necessary to take measures such as a safe shutdown of the vehicle 1.

### 4. Effects of the Present Embodiment

According to the present embodiment, the temperature estimation process for estimating the temperature of the brake rotor 20 is performed. The temperature estimation process includes calculating the amount of absorbed energy Qᵢₙ absorbed by the brake rotor 20 based on the amount of kinetic energy ΔK that the vehicle 1 loses and the amount of potential energy ΔU that the vehicle 1 loses during braking of the vehicle 1. The temperature estimation process further includes calculating the amount of temperature change ΔT of the brake rotor 20 based on the amount of absorbed energy Qᵢₙ to estimate the temperature T_{R} of the brake rotor 20. According to the above-described temperature estimation process, the amount of change in potential energy, which is not considered in the related art, is taken into consideration and it is thus possible to estimate the temperature T_{R} of the brake rotor 20 with higher accuracy as compared with the related art. Moreover, since there is no need to provide a temperature sensor that directly measures the temperature of the brake rotor 20, the number of components can be reduced.

### 5. Modification Examples

Hereinafter, modification examples of the above-described embodiment will be described. The same or corresponding elements are denoted by the same reference numerals, and redundant description thereof will be omitted.

### 5-1. First Modification Example

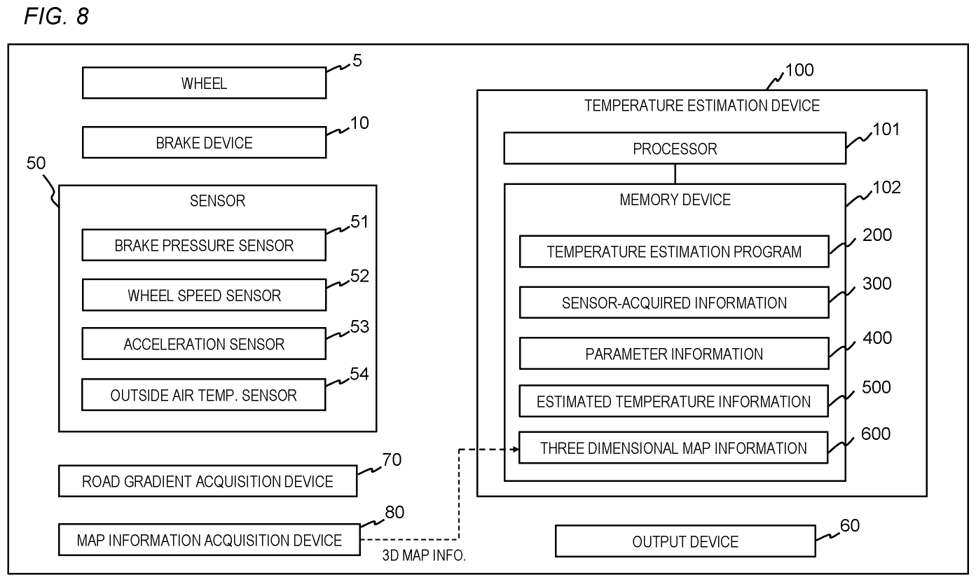

In the above embodiment, the amount of potential energy ΔU that the vehicle 1 loses is calculated by using Equation (4). The amount of potential energy ΔU may be calculated by another method. In the first modification example, the amount of potential energy ΔU is calculated based on altitude information of a travel position of the vehicle 1 that is obtained from three dimensional map information. FIG. 8 shows a configuration of the vehicle 1 of the present modification example. The vehicle 1 shown in FIG. 8 further includes a map information acquisition device 80 in addition to the components of the vehicle 1 shown in FIG. 4.

The map information acquisition device 80 acquires the three dimensional map information from an external server existing outside the vehicle 1, a recording medium connectable to the vehicle 1, or the like. The three dimensional map information includes three dimensional information such as a height of a building, an altitude for each position on a road, a height of a structure on a road, and the like in addition to two dimensional position information of the building, the road, the structure on the road, and the like. The three dimensional map information acquired by the map information acquisition device 80 is transmitted to the memory device 102 and stored as three dimensional map information 600 in the memory device 102.

In the present modification example, in Step S23 of the flowchart shown in FIG. 7, the potential energy variation calculation unit 140 calculates the amount of potential energy ΔU that the vehicle 1 loses during braking by using the altitude information of the travel position of the vehicle 1 included in the three dimensional map information 600. When the altitude of the vehicle 1 changes from H_{before} to H, the amount of potential energy ΔU that the vehicle 1 loses is expressed by the following Equation (12).

[Equation 12]

ΔU=Mg(H_{before}−H) (12)

In the present modification example, the potential energy variation calculation unit 140 calculates the amount of potential energy ΔU by using Equation (12) instead of Equation (4).

According to the present modification example, it is possible to calculate the amount of potential energy ΔU without acquiring the slope angle θ of the road surface on which the vehicle 1 travels. Therefore, the road gradient acquisition device 70 and the acceleration sensor 53 can be omitted.

The amount of potential energy ΔU may be calculated by using both of Equation (4) and Equation (12), and an average value of the two amounts of potential energy ΔU may be calculated. In this case, the temperature of the brake rotor 20 can be estimated with higher reliability.

When the amount of potential energy ΔU is calculated by using Equation (4) and the vehicle 1 has the map information acquisition device 80, the slope angle θ of the road surface on which the vehicle 1 travels may be acquired based on the three dimensional map information. In this case, the road gradient acquisition device 70 and the acceleration sensor 53 can be omitted.

### 5-2. Second Modification Example

In a second modification example, the vehicle 1 is an electric vehicle equipped with a regenerative braking device. Estimating the temperature of the brake rotor 20 in the case where the vehicle 1 is the electric vehicle equipped with the regenerative braking device will be described.

When the vehicle 1 brakes, the frictional heat is generated by the contact between the surface of the brake rotor 20 and the surface of the brake pad 30, and the temperature of the brake rotor 20 increases. The amount of frictional energy of the frictional heat can be calculated based on the amount of change in kinetic energy represented by Equation (1). Here, as described above, the change in vehicle speed of the vehicle 1 is not necessarily entirely caused by friction, but is partly caused by the change in potential energy. Furthermore, the change in vehicle speed of the vehicle 1 is partly caused by the regenerative braking force applied to the vehicle 1 by the regenerative braking device. Therefore, the amount of absorbed energy Qᵢₙ absorbed by the brake device 10 includes not only the amount of first absorbed energy Qᵢₙ₁ and the amount of second absorbed energy Qᵢₙ₂ but also an amount of third absorbed energy Qᵢₙ₃ based on an amount of the regenerative energy. In the present modification example, the temperature estimation device 100 performs the temperature estimation in consideration of the amount of third absorbed energy Qᵢₙ₃ based on the amount of regenerative energy in addition to the amount of first absorbed energy Qᵢₙ₁ and the amount of second absorbed energy Qᵢₙ₂.

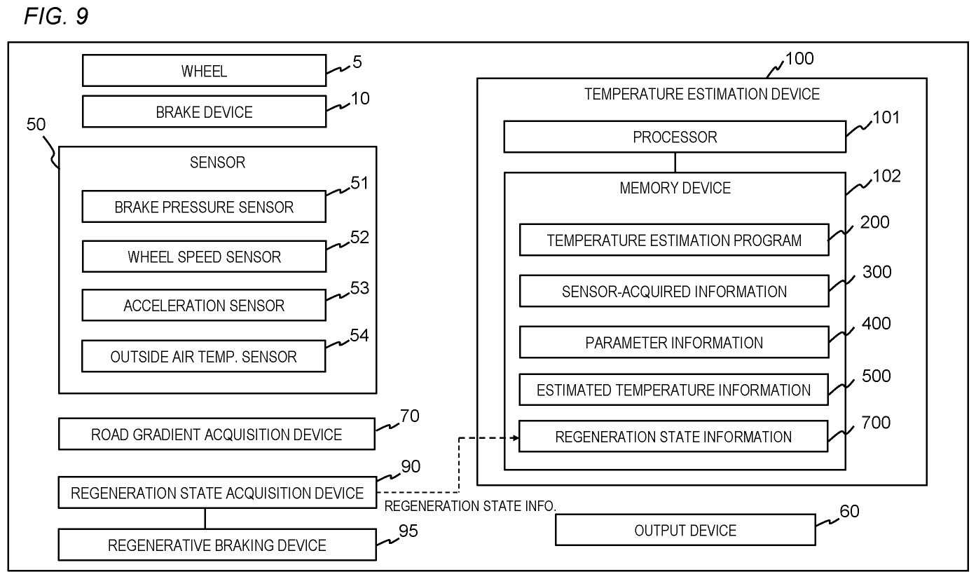

FIG. 9 shows a configuration example of the vehicle 1 of the present modification example. The vehicle 1 shown in FIG. 9 includes a regeneration state acquisition device 90 in addition to the components of the vehicle 1 shown in FIG. 4.

The regeneration state acquisition device 90 acquires regeneration state information of a regenerative braking device 95 mounted on the vehicle 1. The regenerative braking device 95 converts the kinetic energy of the vehicle 1 into the regenerative energy by power generation of a power generator mounted on the vehicle 1, thereby applying the braking force to the vehicle 1. The regeneration state information is information regarding the regeneration by the regenerative braking device 95. For example, the regeneration state acquisition device 90 acquires a regenerative torque Tiw that is a torque applied to the power generator as the regeneration state information. As another example, the regeneration state acquisition device 90 may acquire an electric energy Q_{B} stored in a battery of the vehicle 1 by regeneration. The regeneration state information acquired by the regeneration state acquisition device 90 is transmitted to the memory device 102 and stored as regeneration state information 700 in the memory device 102.

Calculation of an amount of regenerative energy E and calculation of the amount of third absorbed energy Qᵢₙ₃ absorbed by the brake rotor 20 will be described. When the regeneration state information 700 is the regenerative torque T_{HV}, the amount of regenerative energy E is expressed by the following Equation (13).

$$[ Equation 13 ]$$

$$E = \frac{{T}_{HV}}{2 R} * V * Δ t \qquad ( 13 )$$

Here, R is a radius of the brake rotor 20. When the regeneration state information 700 is the electric energy Q_{B} stored in the battery of the vehicle 1, the amount of regenerative energy E is expressed by the following Equation (14).

[Equation 14]

E=Q_{B} (14)

Based on the regenerative energy amount E, the amount of third absorbed energy Qᵢₙ₃ absorbed by the brake rotor 20 is expressed by the following Equation (15).

[Equation 15]

Qᵢₙ₃=−E*C₃ (15)

Here, C₃ is a regeneration loss coefficient that indicates an energy loss caused by resistance and the like due to friction in portions other than the regenerative braking device 95. The sign − (minus) means that when the amount of regenerative energy E is positive, the amount of third absorbed energy Qᵢₙ₃ is negative and the amount of absorbed energy Qᵢₙ becomes small.

Based on the amount of third absorbed energy Qᵢₙ₃ described above, the amount of absorbed energy Qᵢₙ absorbed by the brake rotor 20 is expressed by the following Equation (16).

[Equation 16]

Qᵢₙ=Qᵢₙ₁=Qᵢₙ₂+Qᵢₙ₃ (16)

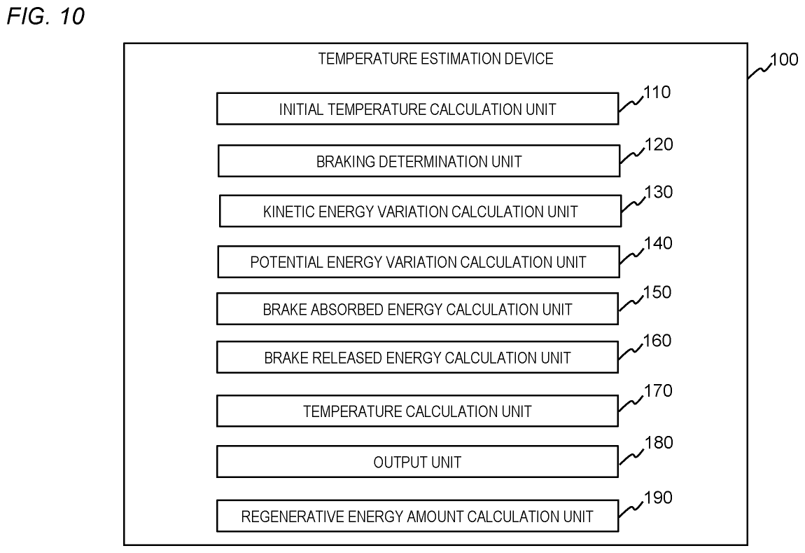

FIG. 10 is a functional block diagram showing an example of the processing performed by the temperature estimation device 100 according to the present modification example. The temperature estimation device 100 includes a regenerative energy amount calculation unit 190 in addition to the functional components showing in FIG. 5.

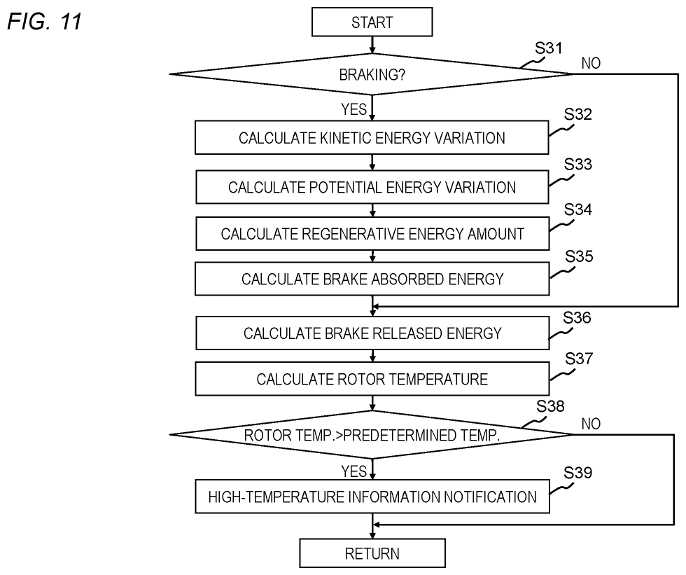

FIG. 11 is a flowchart showing the temperature estimation process according to the present modification example. In the present modification example, a process of Step S34 is executed in addition to the steps shown in the flowchart of FIG. 7 (it should be noted that processes of Steps S31 to S33 in FIG. 11 respectively correspond to the processes of Steps S21 to S23 in FIG. 7, and processes of steps S35 to S39 in FIG. 11 respectively correspond to the processes of Steps S24 to S28 in FIG. 7).

In Step S34, the regenerative energy amount calculation unit 190 first calculates the amount of regenerative energy E based on the regenerative state information 700. The Equation (13) or (14) is used for calculating the amount of regenerative energy E. Thereafter, in Step S35, the brake absorbed energy calculation unit 150 calculates the amount of absorbed energy Qᵢₙ. Equations (3), (5), (15), and (16) are used for calculating the amount of absorbed energy Qᵢₙ.

According to the present modification example, the amount of absorbed energy Qᵢₙ can be calculated in consideration of the amount of regenerative energy caused by the regenerative braking device 95. Therefore, when the vehicle 1 is the electric vehicle having the regenerative braking device 95, the temperature of the brake rotor 20 can be estimated more accurately.

### 5-3. Other Modification Examples

Although Equations (1) to (16) have been used for calculating the above-described parameters and the like, modified or improved equations may be used. For example, Equation (4) describes the amount of potential energy ΔU that the vehicle 1 loses under the assumption that the vehicle 1 travels at the vehicle speed V during the time Δt. Instead of this assumption, it is also possible to use an assumption that the vehicle speed changes linearly from V_{before} to V during the time Δt. In this case, the amount of potential energy ΔU that the vehicle 1 loses is expressed by the following Equation (17).

$$[ Equation 17 ]$$

$$Δ U = Mg Δ t ( \frac{{V}_{before} + V}{2} ) sinθ \qquad ( 17 )$$

Equation (17) above may be used in place of Equation (4).

What is claimed is:

1. A temperature estimation method applied to a brake device that applies a braking force to a vehicle by pressing a friction material against a rotor rotating integrally with a wheel,
the temperature estimation method comprising:
calculating an amount of absorbed energy absorbed by the rotor based on an amount of kinetic energy that the vehicle loses and an amount of potential energy that the vehicle loses during braking of the vehicle; and
estimating a temperature of the rotor based on the amount of absorbed energy.

2. The temperature estimation method according to claim 1, wherein
the amount of absorbed energy includes a sum of an amount of first absorbed energy based on the amount of kinetic energy that the vehicle loses and an amount of second absorbed energy based on the amount of potential energy that the vehicle loses.

3. The temperature estimation method according to claim 1, further comprising calculating the amount of potential energy based on a slope angle of a road surface on which the vehicle travels and a vehicle speed of the vehicle.

4. The temperature estimation method according to claim 1, further comprising calculating the amount of potential energy based on altitude information of a travel position of the vehicle obtained from three dimensional map information.

5. The temperature estimation method according to claim 1, wherein
an amount of regenerative energy is an energy amount of a regenerative braking force applied to the vehicle by a regenerative braking device mounted on the vehicle, and
calculating the amount of absorbed energy includes calculating the amount of absorbed energy based on the amount of kinetic energy that the vehicle loses, the amount of potential energy that the vehicle loses, and the amount of regenerative energy.

6. The temperature estimation method according to claim 5, wherein
the amount of absorbed energy includes a sum of an amount of first absorbed energy based on the amount of kinetic energy that the vehicle loses, an amount of second absorbed energy based on the amount of potential energy that the vehicle loses, and an amount of third absorbed energy based on the amount of regenerative energy.

7. The temperature estimation method according to claim 5, further comprising calculating the amount of regenerative energy based on a regenerative torque applied to the regenerative braking device.

8. A temperature estimation device applied to a brake device that applies a braking force to a vehicle by pressing a friction material against a rotor rotating integrally with a wheel,
the temperature estimation device comprising one or more processors configured to:
calculate an amount of absorbed energy absorbed by the rotor based on an amount of kinetic energy that the vehicle loses and an amount of potential energy that the vehicle loses during braking of the vehicle; and
estimate a temperature of the rotor based on the amount of absorbed energy.

9. A non-transitory computer-readable recording medium on which a temperature estimation program is recorded, wherein
the temperature estimation program, which is applied to a brake device that applies a braking force to a vehicle by pressing a friction material against a rotor rotating integrally with a wheel, causes a computer to execute:
calculating an amount of absorbed energy absorbed by the rotor based on an amount of kinetic energy that the vehicle loses and an amount of potential energy that the vehicle loses during braking of the vehicle; and
estimating a temperature of the rotor based on the amount of absorbed energy.
